(19) United States
(12) Patent Application Publication
(10) Pub. No.: US 2018/0209210 A1
(43) Pub. Date: Jul. 26, 2018

(54) System of vehicular access for a pet

(71) Applicant: Thomas Terry Arndt, Cinebar, WA (US)

(72) Inventor: Thomas Terry Arndt, Cinebar, WA (US)

(21) Appl. No.: 15/880,520

(22) Filed: Jan. 25, 2018

Related U.S. Application Data
(60) Provisional application No. 62/450,175, filed on Jan. 25, 2017.

(51) Int. Cl. E06B 7/32; B65G 69/28

(52) U.S. Cl. CPC E06B 7/32; B60J 5/0412; B65G 69/28

(57) ABSTRACT

The system of vehicular access for a pet is an apparatus that allows a pet to enter and exit a vehicle without any assistance from a user. The apparatus includes a vehicle, a pet door, at least one door actuator, a control unit, at least one control panel, and a power source. The vehicle transports the user, passengers, and the pet. The vehicle includes a main door and an access opening. The access opening allows the passage of the pet into and out of the vehicle through the main door. The pet door closes and opens the access opening. The at least one door actuator allows the user to automatically operate the pet door. The control unit processes the commands from the at least one control panel which are inputted by the user with the at least one control panel. The power source provides the necessary power to the at least one door actuator.

The current application claims a priority to the U.S. Provisional Patent application Ser. No. 62/450,175 filed on Jan. 25, 2017.

### FIELD OF THE INVENTION

The present invention generally relates to pet supplies. More specifically, the present invention is a system of vehicular access for a pet integrated in a vehicle.

### BACKGROUND OF THE INVENTION

Given the economic status and societal values of today, younger couples and individuals opt to have a pet instead of children. More specifically, at least half of couples and individuals have a pet instead of children or choose to have a pet before having children. Having a pet before having children may not require as much responsibility as that of having children but taking care of a pet aids in the preparation of having children.

Therefore, it is an objective of the present invention to facilitate the transportation of a pet. Each pet is an individual and responds to situations differently. The present invention not only eases the task for the user of aiding and guiding the pet into and out of the vehicle but facilitates the entry and exit of the pet. The present invention preserves the structurally integrity of the vehicle and enhances the safety of the transportation of the pet. The present invention allows the user to open and close the point of entry of the pet within the vehicle without manually input.

### BRIEF DESCRIPTION OF THE DRAWINGS

FIG. 1 is a perspective view of the of the present invention, in an open configuration.

FIG. 2 is a perspective view of the of the present invention, in a closed configuration.

FIG. 3 is a side cross-sectional view of the pet door and the gripping mat of the present invention.

FIG. 4 is a schematic view of the of the pet door, the gripping mat, and the safety reflector of the present invention.

FIG. 5 is a schematic view of the at least one door actuator of the present invention.

FIG. 6 is a schematic view of the connections of electronic components of the present invention.

FIG. 7 is a schematic view of the of the locking mechanism of the present invention.

FIG. 8 is a schematic view of the of the safety sensor of the present invention.

### DETAIL DESCRIPTIONS OF THE INVENTION

All illustrations of the drawings are for the purpose of describing selected versions of the present invention and are not intended to limit the scope of the present invention.

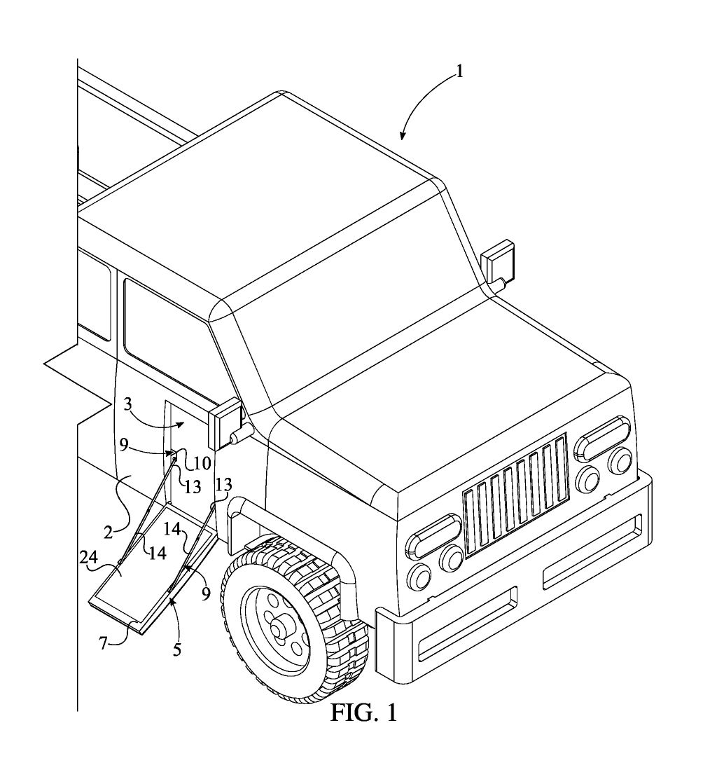

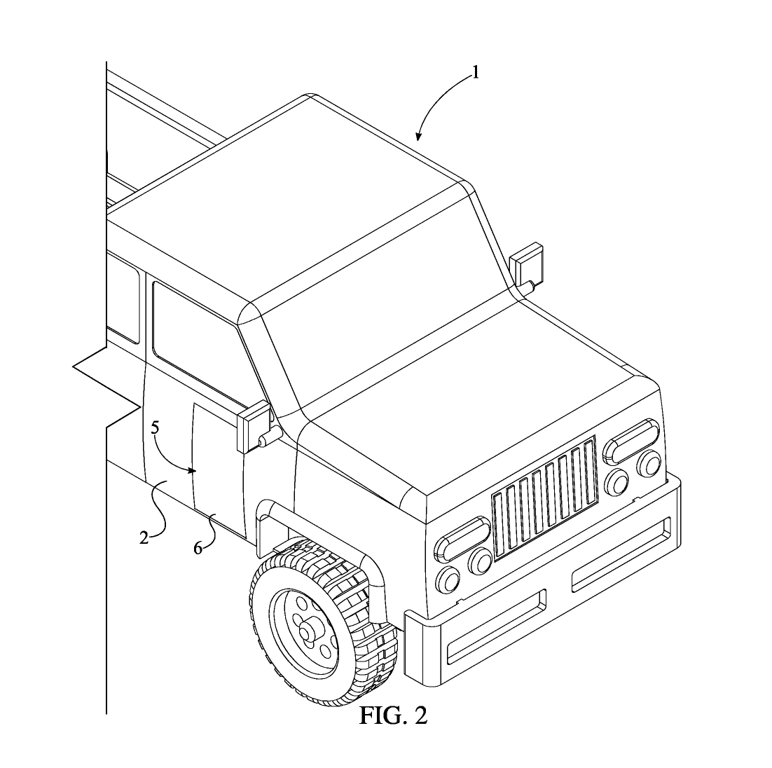

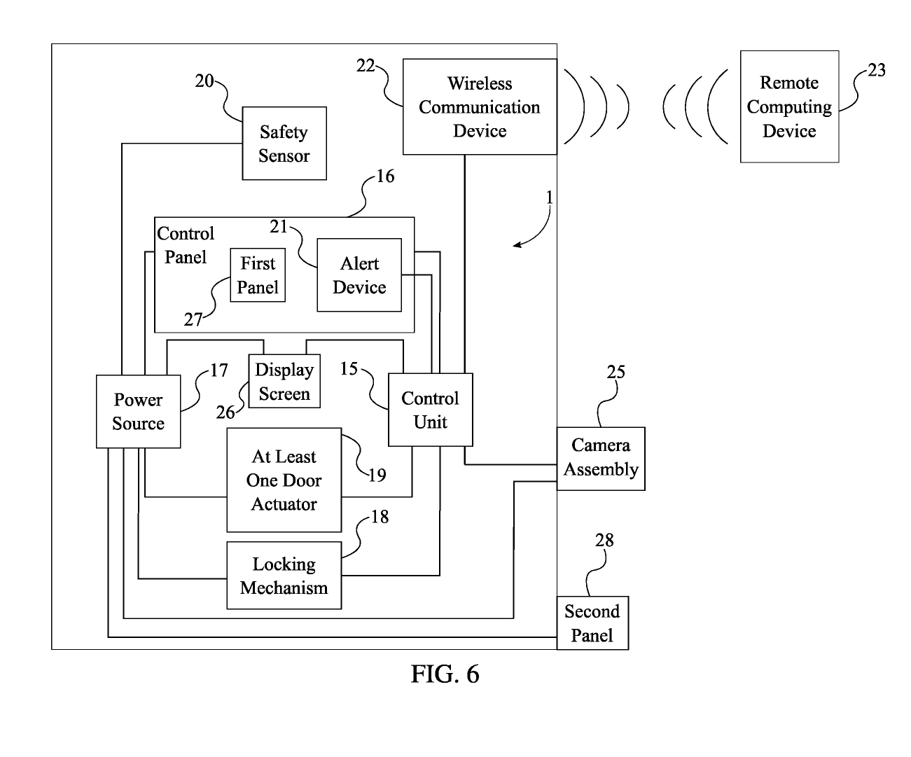

The present invention is a system of vehicular access for a pet that facilitates the entry and exit of a pet through a vehicle. A user may control the system of vehicular access for a pet remotely. Furthermore, the present invention preserves the structural integrity of the vehicle in order to protect individuals and pets within the vehicle. As seen in FIG. 1, FIG. 2, and FIG. 6, the present invention comprises a vehicle 1, a pet door 5, at least one door actuator 9, a control unit 15, at least one control panel 16, and a power source 17. The vehicle 1 transports a user, passengers, and pets. More specifically, the vehicle 1 comprises a main door 2 and an access opening 3. The main door 2 allows the user and passengers to enter the vehicle 1. The main door 2 is preferably a passenger door of the vehicle 1. However, it is understood that the main door 2 may be the driver's door of the vehicle 1 or any other entry point within the cabin of the vehicle 1. The access opening 3 accommodates the integration of the pet door 5 within the main door 2. The pet door 5 allows a pet to enter the vehicle 1 without opening the main door 2. The pet door 5 also defines a path of the pet within the vehicle 1 through the access opening 3. The at least one door actuator 9 automatically opens and closes the access opening 3 with the pet door 5. The control unit 15 implements commands from the at least one control panel 16 and controls the at least one door actuator 9. The at least one control panel 16 allows the user to automatically control the extension and retraction of the pet door 5. The power source 17 provides the necessary power to the at least one door actuator 9. The power source 17 is preferably a portable battery, however, in an alternate embodiment of the present invention, the power source 17 is a battery of the vehicle 1.

The overall configuration of the aforementioned components allows a user to open and close the pet door 5 while sitting in the driver's seat while preserving the structural integrity of the vehicle 1. As seen in FIG. 1, the access opening 3 laterally traverses through the main door 2, allowing the pet to enter the vehicle 1 through the main door 2. In order for the access opening 3 to be sealed upon the entry and exit of the pet, the pet door 5 is coextensive with the access opening 3. The pet door 5 is hingedly connected along a lower edge 4 of the access opening 3 so that the pet may walk across the pet door 5 as the pet enters and exits the vehicle 1. The rotation of the pet door 5 about lower edge 4 is automatically controlled as the least one door actuator is operatively coupled in between the main door 2 and the pet door 5, wherein the at least one door actuator 9 is used to open and close the pet door 5 from the access opening 3. The control unit 15 is positioned within the vehicle 1, allowing only the user and designated passengers to remotely operate the opening and closing of the access opening 3 with the pet door 5. The user and designated passengers are able to remotely operate the opening and closing of the pet door 5 as the control unit 15 is electronically connected to the at least one door actuator 9 and the at least one control panel 16. Moreover, the power source 17 is electrically connected to the at least one door actuator 9.

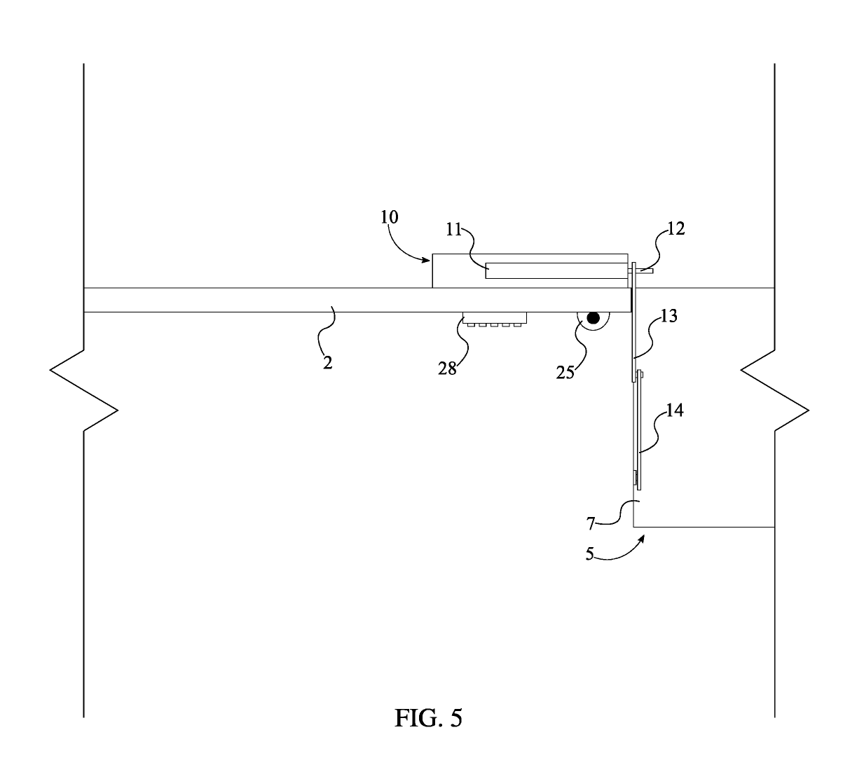

In the preferred embodiment of the present invention, the at least one door actuator 9 comprises a motor 10, a pull arm 13, and a push arm 14, as shown in FIG. 1 and FIG. 5. The motor 10 controls the movement of the pull arm 13, and consequently both the push arm 14 and the pet door 5. The pull arm 13 and push arm 14 extend and retract the pet door 5. Furthermore, the pull arm 13 and the push arm 14, together, support the connection between the pet door 5 and the main door 2 and uphold the pet door 5 and the pet traversing across the pet door 5. In order to provide a continuous path for the pet from the vehicle 1 to the ground, and vice versa, a stator 11 of the motor 10 is mounted onto the main door and is positioned within the vehicle 1, opposite the lower edge 4 of the access opening 3. This arrangement also structurally supports the weight of the pet on the pet door 5. A rotor 12 of the motor 10 is terminally and torsionally connected to the pull arm 13 in order for the rotor 12 to be able to control the push arm 14 as well. Furthermore, the push arm 14 is terminally and hingedly connected to the pull arm 13, opposite the motor 10 so that upon the retraction of the push arm 14 and the pull arm 13 occupy as little space within the vehicle 1 while in a collapsed configuration. The pet door 5 is hingedly and terminally connected to the push arm 14, opposite the pull arm 13, accommodating the rotation of the pet door 5 about the lower edge 4 of the access opening 3. More specifically, the hinged connection between the pull arm 13 and the push arm 14 and the hinged connection between the main door 2 and the pet door 5 is positioned offset from each other across the pet door 5.

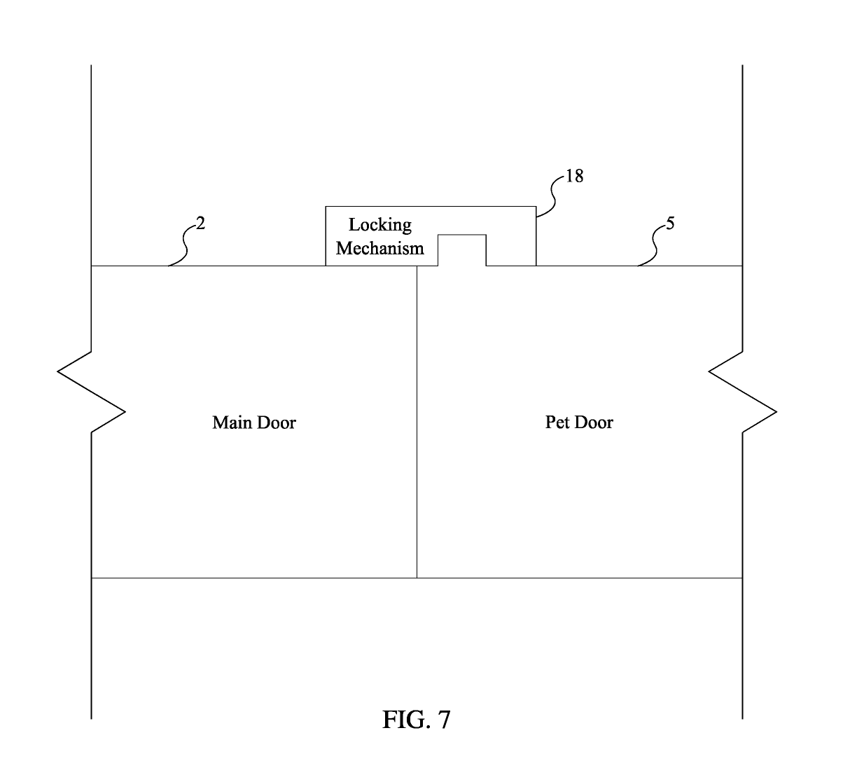

In order to ensure the pet door 5 does not accidentally open as a result of force or accidental engagement of the at least one control panel 16, the present invention further comprises a locking mechanism 18, shown in FIG. 7. The locking mechanism 18 may be a latch, a cam lock, a deadbolt, a rim latch and so on. The locking mechanism 18 is operatively coupled in between the pet door 5 and the main door 2, wherein the locking mechanism 18 is used to lock and unlock the pet door 5 from the main door 2. In the preferred embodiment of the present invention, the control unit 15 is electronically connected to the locking mechanism 18, and the power source 17 is electrically connected to the locking mechanism 18. Therefore, in the preferred embodiment of the present invention, the user is able to automatically and remotely control the locking mechanism 18 with the at least one control panel 16.

The safety of the present invention is further enhanced as the preferred embodiment of the present invention further comprises a camera assembly 25 and a display screen 26, seen in FIG. 5 and FIG. 6. The camera assembly allows the user to easily see the surrounding environment of the access opening 3 with the display screen 26. The user may only operate the at least one door actuator 16 with the at least one control panel 16 if the surrounding environment is clear. The display screen 26 presents real-time images and videos to the user without the user having to constantly view the area around the access opening 3. In order to present real-time images and videos of the surrounding environment, the camera assembly 25 is externally connected to the main door 2, adjacent the access opening 3. The user within the vehicle is able to view the surrounding environment without directly looking at the surrounding environment as the display screen 26 is positioned within the vehicle 1. The camera assembly 25 is able to transmit the real-time images and videos to the display screen 26 as the control unit 15 is electronically connected to the camera assembly 25 and the display screen 26. Similar to the locking mechanism 18, the control unit 15 is electronically connected the camera assembly 25 and the display screen 26.

In the preferred embodiment of the present invention, the at least one control panel 16 comprises a first panel 27 and a second panel 28, shown in FIG. 5 and FIG. 6. The first panel 27 allows at least one door actuator 9 to be controlled from within the vehicle 1 without the user having to be positioned beside the access opening 3. The first panel 27 is preferably positioned adjacent a driver's seat of the vehicle 1. The second panel 28 allows the at least one door actuator 9 to be controlled from outside of the vehicle 1 without the user having to enter the vehicle 1, thereby allowing the user to safely situate the pet within the vehicle 1 first. More specifically, the first panel 27 is positioned within the vehicle 1, and the second panel 28 is externally mounted to the main door 2, adjacent to the access opening 3.

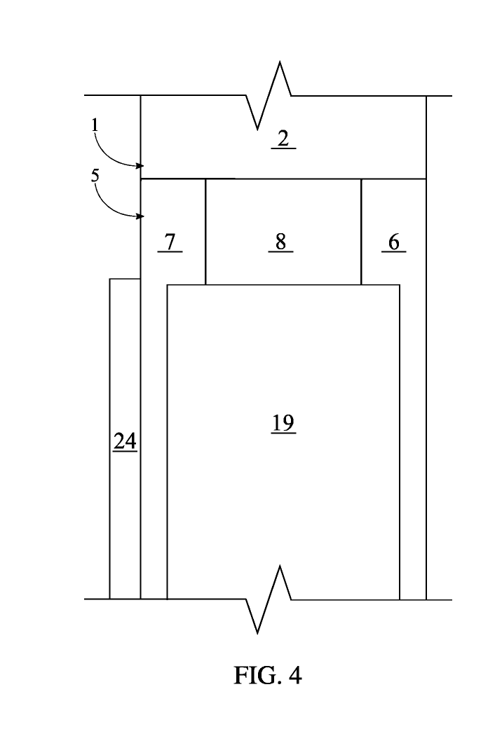

The present invention preserves the structural integrity of the vehicle 1 as the pet door 5 comprises an outer door shell 6 and a ramp 7, as shown in FIG. 1, FIG. 2, and FIG. 4. The outer shell shields the ramp 7 from any direct contact along the exterior of the vehicle 1 and the pet door 5. The ramp 7 facilitates the entry and exit of the pet into and out of the vehicle 1 and provides a continuous path from the ground into and out of the vehicle 1. The outer door shell 6 is configured to be flush with an outer vehicle 1 shell of the vehicle 1, thereby maintaining the overall exterior structure of the outer vehicle 1 shell. The pet is able to continuously traverse across the ramp 7 without tripping or getting injured as the ramp 7 is mounted across the outer door shell 6.

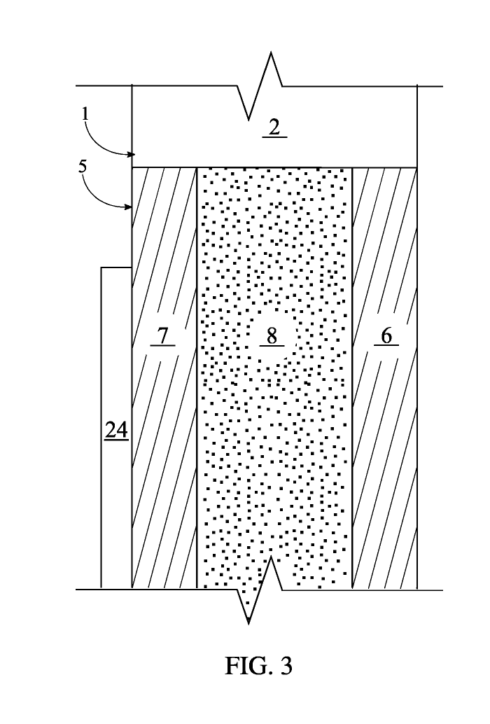

In the preferred embodiment of the present invention, the pet door 5 further comprises a reinforcement layer 8, shown in FIG. 3. The reinforcement layer 8 absorbs any force from direct contact across the outer door shell 6. The reinforcement layer 8 is structurally integrated in between the outer door shell 6 and the ramp 7. Moreover, in the preferred embodiment of the present invention, the ramp 7 is planar, further facilitating the entry and exit of the pet into and out of the vehicle 1. The preferred embodiment of the present invention further comprises a gripping mat 24, shown in FIG. 1, FIG. 3, and FIG. 4. The gripping mat 24 increases the friction between the pet and the pet door 5 so that the pet does not slip along the incline of the pet door 5 while entering and exiting. The gripping mat 24 is connected across the pet door 5 and is positioned within the vehicle 1. This arrangement provides a friction-inducing surface along the surface of the pet door 5 which the pet comes into contact with as the pet enters and exits the vehicle 1.

In order to enhance the safety of the present invention, the preferred embodiment of the present invention further comprises at least one safety reflector 19, shown in FIG. 4. The at least one safety reflector 19 serves as a visual alert when the pet door 5 is extended and the access opening 3 is opened. The at least one safety reflector 19 is laterally mounted to the pet door 5 and is positioned in between the outer door shell 6 and the ramp 7. This arrangement maximizes the reflection of light against the at least one safety reflector 19, thereby increasing safety of the present invention. In alternate embodiments of the present invention, the at least one safety reflector 19 may be positioned across a variety of surfaces of the pet door 5. The at least one safety reflector 19 is only visible with the pet door 5 extended from the access opening 3.

Wherein the pet door 5 and the access opening 3 are in a closed configuration, the pet door 5 is positioned within the access opening 3, and the pet door 5 is hermetically sealed with the main door 2, illustrated in FIG. 2. This arrangement prevents any leakage from the exterior of the vehicle 1 and the pet door 5 from entering the interior of the vehicle 1 through the access opening 3. Wherein the pet door 5 and the access opening 3 are in open configuration, the pet door 5 is angularly offset from the access opening 3 about the lower edge 4 of the access opening 3, illustrated in FIG. 1. This arrangement allows the pet to enter and exit the access opening 3 without damaging the pet door 5 and ensure the safety of the pet.

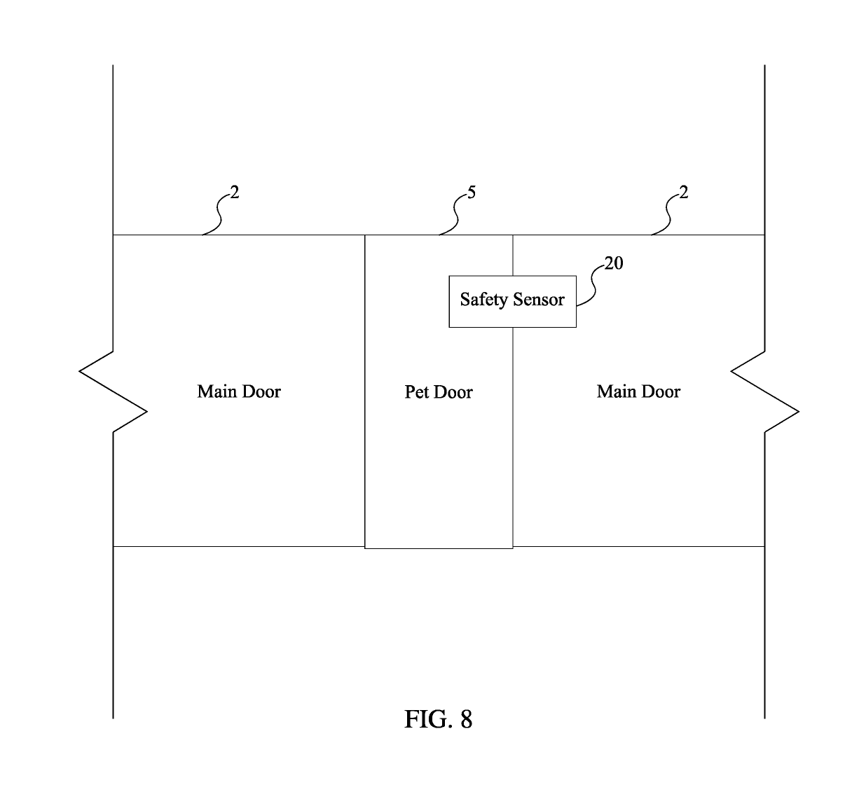

The present invention is able to detect if the pet door 5 and the access opening 3 are in a closed configuration and in an open configuration as the present invention further comprises a safety sensor 20 and an alert device 21, shown in FIG. 6 and FIG. 8. The safety sensor 20 detects when the pet door 5 is in an open configuration. The alert device 21 notifies the user if the pet door 5 is in an open configuration, indicating that the vehicle 1 is unfit to drive. In order to detect an open configuration, the safety sensor 20 is operatively coupled in between the pet door 5 and the access opening 3, wherein the safety sensor 20 is used to detect an angular offset between the pet door 5 and the access opening 3 about the lower edge 4 of the access opening 3. In order to notify the user, the safety sensor 20 and the alert device 21 is electrically connected to the power source 17. More specifically, the alert device 21 is connected within the vehicle 1. In the preferred embodiment of the present invention, the alert device 21 is operatively integrated within the at least one control panel 16.

If the user is not able to directly access the at least one control panel 16, the user may still engage the at least one control panel 16 as the present invention further comprises a wireless communication device 22 and a remote computing device 23, as seen in FIG. 6. The wireless communication device 22 allows the user to input commands with the remote computing device 23 and control the at least one door actuator 9 and any other electronic components connected to the control unit 15. The wireless communication device 22 receives the commands from the remote computing device 23 and allows the control unit 15 to process the received commands. In order to process commands from the remote computing device 23, the control unit 15 is electronically coupled to the wireless communication device 22. In order to deliver commands to the control unit 15 from the remote computing device 23, the remote computing device 23 is communicably coupled to the wireless communication device 22.

Although the invention has been explained in relation to its preferred embodiment, it is to be understood that many other possible modifications and variations can be made without departing from the spirit and scope of the invention as hereinafter claimed.

What is claimed is:

1. A system of vehicular access for a pet comprises:
a vehicle;
a pet door;
at least one door actuator;
a control unit;
at least one control panel;
a power source;
the vehicle comprises a main door and an access opening;
the access opening laterally traversing through the main door;
the pet door being coextensive with the access opening;
the pet door being hingedly connected along a lower edge of the access opening;
the at least one door actuator being operatively coupled in between the main door and the pet door, wherein the at least one door actuator is used to open and close the pet door from the access opening;
the control unit being positioned within the vehicle;
the control unit being electronically connected to the at least one door actuator and the at least one control panel; and,
the power source being electrically connected to the at least one door actuator;

2. The system of vehicular access for a pet as claimed in claim 1 comprises:
the at least one door actuator comprises a motor, a pull arm, and a push arm;
a stator of the motor being mounted onto the main door;
the stator of motor being positioned within the vehicle, opposite the lower edge of the access opening;
a rotor of the motor being terminally and torsionally connected to the pull arm;
the push arm being terminally and hingedly connected to the pull arm, opposite the motor;
the pet door being hingedly and terminally connected to the push arm, opposite the pull arm; and,
the hinged connection between the pull arm and the push arm and the hinged connection between the main door and the pet door being positioned offset from each other across the pet door.

3. The system of vehicular access for a pet as claimed in claim 1 comprises:
a locking mechanism; and,
the locking mechanism being operatively coupled in between the pet door and the main door, wherein the locking mechanism is used to lock and unlock the pet door from the main door.

4. The system of vehicular access for a pet as claimed in claim 3 comprises:
the control unit being electronically connected to the locking mechanism; and,
the power source being electrically connected to the locking mechanism.

5. The system of vehicular access for a pet as claimed in claim 3 comprises:
the control unit being electronically connected to the locking mechanism; and,
the power source being electrically connected to the locking mechanism.

6. The system of vehicular access for a pet as claimed in claim 1 comprises:
a camera assembly;
a display screen;
the camera assembly being externally connected to the main door, adjacent the access opening;
the display screen being positioned within the vehicle;
the control unit being electronically connected to the camera assembly and the display screen; and,
the power source being electrically connected to the to the camera assembly and the display screen.

7. The system of vehicular access for a pet as claimed in claim 1 comprises:
the at least one control panel comprises a first panel; and,
the first panel being positioned within the vehicle.

8. The system of vehicular access for a pet as claimed in claim 1 comprises:
the at least one control panel comprises a second panel; and,
the second panel being externally mounted to the main door, adjacent to the access opening.

9. The system of vehicular access for a pet as claimed in claim 1 comprises:
the pet door comprises an outer door shell and a ramp;
the outer door shell being configured to be flush with an outer vehicle shell of the vehicle; and,
the ramp being mounted across the outer door shell.

10. The system of vehicular access for a pet as claimed in claim 9 comprises:
the pet door further comprises a reinforcement layer; and,
the reinforcement being structurally integrated in between the outer door shell and the ramp.

11. The system of vehicular access for a pet as claimed in claim 9, wherein the ramp is planar.

12. The system of vehicular access for a pet as claimed in claim 9 comprises:
at least one safety reflector;
the at least one safety reflector being laterally mounted to the pet door; and,
the at least one safety reflector being positioned in between the outer door shell and the ramp.

13. The system of vehicular access for a pet as claimed in claim 1 comprises:
wherein the pet door and the access opening are in a closed configuration;
the pet door being positioned within the access opening; and,
the pet door being hermetically sealed with the main door.

14. The system of vehicular access for a pet as claimed in claim 1 comprises:
wherein the pet door and the access opening are in an open configuration; and,
the pet door being angularly offset from the access opening about the lower edge of the access opening.

15. The system of vehicular access for a pet as claimed in claim 1 comprises:
a safety sensor;
an alert device;
the safety sensor being operatively coupled in between the pet door and the access opening, wherein the safety sensor is used to detect an angular offset between the pet door and the access opening about the lower edge of the access opening;
the safety sensor and the alert device being electronically connected to the control unit;
the safety sensor and the alert device being electrically connected to the power source; and,
the alert device being connected within the vehicle.

16. The system of vehicular access for a pet as claimed in claim 15 comprises:
the alert device being operatively integrated within the at least one control panel.

17. The system of vehicular access for a pet as claimed in claim 1 comprises:
a wireless communication device;
a remote computing device;
the control unit being electronically coupled to the wireless communication device; and,
the remote computing device being communicably coupled to the wireless communication device.

18. The system of vehicular access for a pet as claimed in claim 1 comprises:
a gripping mat;
the gripping mat being connected across the pet door; and,
the gripping mat being positioned within the vehicle.
